(19) United States
(12) Patent Application Publication
(10) Pub. No.: US 2014/0231232 A1
(43) Pub. Date: Aug. 21, 2014

(54) SWITCH DEVICE

(71) Applicants: Koji Mori, Aichi (JP); Yuichi Fujii, Aichi (JP); Muneki Nishii, Aichi (JP)

(72) Inventors: Koji Mori, Aichi (JP); Yuichi Fujii, Aichi (JP); Muneki Nishii, Aichi (JP)

(73) Assignee: OMRON AUTOMOTIVE ELECTRONICS CO., LTD., Aichi (JP)

(21) Appl. No.: 14/181,155

(22) Filed: Feb. 14, 2014

(30) Foreign Application Priority Data
Feb. 15, 2013 (JP) 2013-027272

(51) Int. Cl. H01H 23/06

(52) U.S. Cl. CPC H01H 23/06
USPC 200/302.3

(57) ABSTRACT

A switch device has an operation part, an upper case in which a hollow tube supporting the operation part is formed, a lower case that is fitted in the upper case, a first drain hole opened upward provided near the tube of the upper case, and a second drain hole opened downward provided in the lower case. The second drain hole communicates with the first drain hole.

### BACKGROUND OF THE INVENTION

1. TECHNICAL FIELD

The present invention relates to a switch device provided with a waterproof structure that prevents water from invasion from outside.

2. RELATED ART

An automobile includes an automatic window switch in order to perform opening and closing control of a window. Generally the automatic window switch includes an operation knob that is manually operated, a case that swingably supports the operation knob, and a circuit board that is accommodated in the case. The case includes an upper case and a lower case. An operation part is provided on an upper side of the upper case, and a lower side of the upper case is opened. The lower case is fitted in the upper case so as to close the lower side of the upper case. A contact part that switches in response to the operation of the operation knob and an electronic component constituting an electric circuit are provided on the circuit board.

In the automatic window switch, sometimes rainwater invading through an opened window or spilled beverages (hereinafter collectively referred to as “water”) invade into the case. The water invading into the case adheres to the circuit board to generate a shortcircuit of the electric circuit or corrosion of the contact part, which causes a malfunction of the switch. Particularly, in the case that a hollow tube that swingably supports the operation knob is provided in an upper surface of the case, unfortunately the flowing-down water rises from a lower side of the operation knob through a gap between the operation knob and the tube, and invades into the case through an upper opening of the tube. Japanese Unexamined Patent Publication Nos. 2006-351443 and 2007-42328 disclose switch devices that prevent the water invasion in the above pathway.

In the switch device of Japanese Unexamined Patent Publication No. 2006-351443, a depression is provided near the tube supporting the operation knob, and a visor-shape top that partially covers the depression is provided on the tube side of the depression. Therefore, the top prevents the water flowing below the operation knob from entering the depression and from rising toward the gap between the operation knob and the tube. The water in the depression is drained from one opened end of the depression. Therefore, the water can be prevented from invading into the case through the tube.

In the switch device of Japanese Unexamined Patent Publication No. 2007-42328, a horizontally-sloped guide portion is provided near the operation knob in the upper surface of the case. Even if the water drops on the vicinity of the operation knob, the water flows along the slope of the guide portion, and is drained to both sides of the case. Therefore, the water can be prevented from invading into the case through the tube.

In the switch device of Japanese Unexamined Patent Publication No. 2006-351443, one end of the depression is opened, and the water entering the depression is drained to the lateral side of the case from the opened end. In the switch device of Japanese Unexamined Patent Publication No. 2007-42328, the water flowing in the guide portion is also drained to the lateral side of the case. When the water is only drained to the lateral side of the case, possibly the drained water flows down along a sidewall of the case, and invades undesirably into the case through the fitting portion between the upper case and the lower case.

### SUMMARY

According to one or more embodiments of the present invention, a switch device can prevent water from invading into the case through the tube and prevent the drained water from invading into the case.

In accordance with one or more embodiments of the present invention, a switch device includes: an operation part; an upper case in which a hollow tube supporting the operation part is formed; and a lower case that is fitted in the upper case. In the switch device, a first drain hole opened upward is provided near the tube of the upper case, and a second drain hole opened downward is provided in the lower case, the second drain hole being communicated with the first drain hole.

According to the above structure, the first drain hole provided in the upper case and the second drain hole provided in the lower case are communicated with each other, so that the flowing-down water can be drained downward through the first drain hole and the second drain hole. Therefore, the water can be prevented from invading into the switch device from below the operation part through the tube. Additionally, the water is drained downward from the second drain hole made on the rear side of the switch device, so that the drained water can be prevented from invading undesirably into the case through the fitting portion between the upper case and the lower case along the sidewall of the case.

In the switch device, a slope may be formed in an upper surface of the upper case in order to guide water to the first drain hole.

In the switch device, a pair of the slopes may be provided with the first drain hole interposed therebetween.

In the switch device, the first drain hole and the second drain hole may be communicated with each other through a hollow drain pipe.

In the switch device, the drain pipe may be formed while being integral with the upper case or the lower case, and a front end of the drain pipe may extend to the second drain hole or the first drain hole.

The switch device may further include a circuit board that is accommodated in an internal space formed by the upper case and the lower case. In the switch device, a through-hole pierced by the drain pipe may be provided in the circuit board.

Accordingly, one or more embodiments of the present invention can provide the switch device that prevents water from invading into the case through the tube and prevents the drained water from invading into the case.

### BRIEF DESCRIPTION OF THE DRAWINGS

FIG. 1 is an exploded perspective view illustrating a switch device according to one or more embodiments of the present invention;

FIG. 2 is an assembly drawing of the switch device in FIG. 1;

FIG. 3 is a view of the switch device in FIG. 2 when viewed from a rear side;

FIG. 4 is a perspective view of a lower case;

FIG. 5 is a plan view of the switch device in FIG. 1;

FIG. 6 is a rear view of the switch device in FIG. 1;

FIG. 7 is a side view of the switch device in FIG. 1;

FIG. 8 is a cross-sectional view taken on line A-A in FIG. 5; and

FIG. 9 is an enlarged cross-sectional view of D portion in FIG. 8.

### DETAILED DESCRIPTION

Hereinafter, embodiments of the present invention will be described with reference to the drawings. In the drawings, similar or equivalent components are designated by identical numerals. The symbol X indicated by an arrow expresses a front-back direction, the symbol Y expresses a horizontal direction, and the symbol Z expresses a vertical direction. The symbol F in the X-direction expresses a frontward direction, the symbol B expresses a backward direction, the symbol L in the Y-direction expresses a leftward direction, the symbol R expresses a rightward direction, the symbol U in the Z-direction expresses an upward direction, and the symbol D expresses a downward direction. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

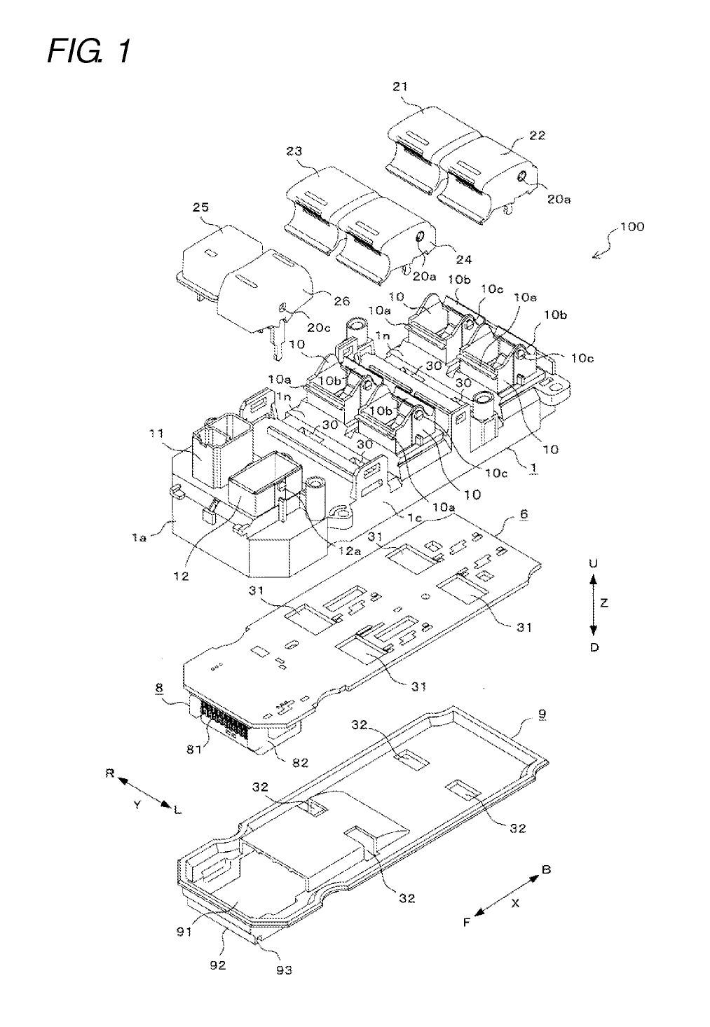

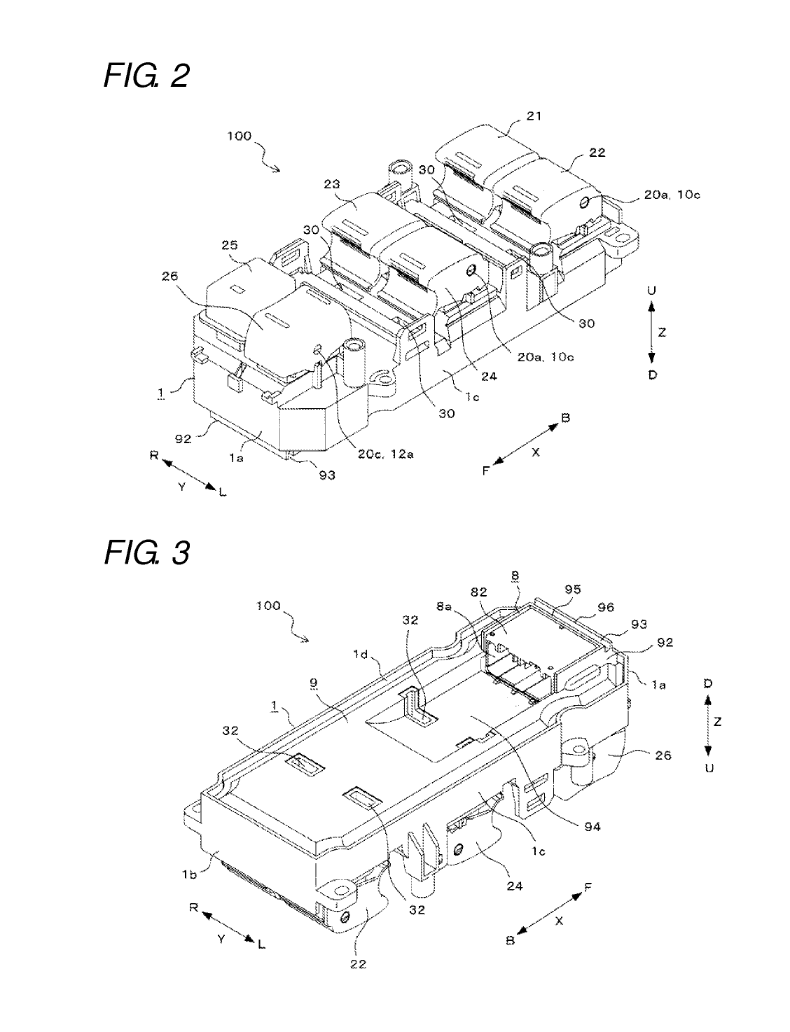

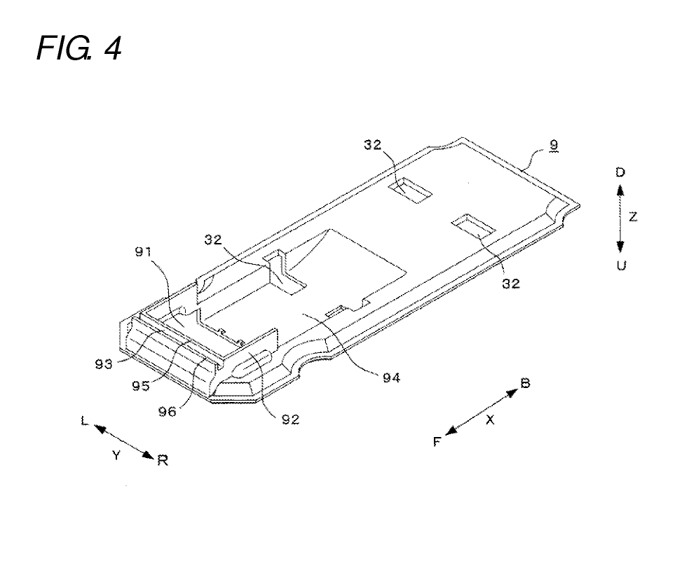

A switch device 100 is a vehicle automatic window switch that is attached to, for example, an armrest (not illustrated) provided inside a door of a driver's seat. As illustrated in FIGS. 1 and 2, the switch device 100 includes plural operation knobs 21 to 26, an upper case 1 to which the operation knobs 21 to 26 are attached, a lower case 9 that is fitted in the upper case 1, and a circuit board 6 that is accommodated in an internal space S (see FIG. 8) formed between the upper case 1 and the lower case 9. The operation knobs 21 to 26 are an example of the “operation part” of one or more embodiments of the present invention.

The upper case 1 is formed into a box shape including four sidewalls 1a to 1d (see FIG. 3). A lower side (D-direction side) of the upper case 1 is opened. The lower case 9 is formed into a flat shape, and fitted in the upper case 1 to close the lower side of the upper case 1. For example, the lower case 9 can be fitted in the upper case 1 by such a well-known method that a protrusion (not illustrated) formed in the lower case 9 is engaged in a notch (not illustrated) formed in the upper case 1.

The operation knobs 21 to 24 are attached to four hollow tubes 10 provided on an upper surface of the upper case 1. Particularly, shaft portions 10c formed in the tubes 10 of the upper case 1 are fitted in holes 20a formed in the operation knobs 21 to 24, whereby the operation knobs 21 to 24 are swingably supported about the shaft portions 10c. For example, the operation knobs 21 to 24 are operated in the case that windows of the driver's seat, a passenger's seat, a left rear seat, and a right rear seat are opened and closed.

The push-type operation knob 25 is supported by a hollow tube 11, which is provided on the upper surface of the upper case 1, while being vertically movable. For example, the operation knob 25 is operated in the case that the windows of the passenger's seat and the rear seats are prohibited to be opened and closed or in the case that the prohibition is lifted.

The seesaw-type operation knob 26 is attached to a hollow tube 12 provided on the upper surface of the upper case 1. Particularly, a shaft portion 12a formed in the tube 12 of the upper case 1 is fitted in a hole 20c formed in the operation knob 26, whereby the operation knob 26 is swingably supported about the shaft portion 12a. For example, the operation knob 26 is operated in the case that the doors of each seat are locked or unlocked.

As illustrated in FIG. 1, a rib 10a projecting forward is provided in a sidewall on a frontward side (F-direction side) of each tube 10, and a V-shape groove 10b is provided at an upper end of a sidewall on a backward side (B-direction side). Both ends of the groove 10b are opened. As illustrated in FIG. 8, an inverse V-shape groove 20b corresponding to the groove 10b is provided in a rear portion of each of the operation knobs 21 to 24.

In the upper surface of the upper case 1, rectangular drain holes 30 (first drain hole) are provided near the tubes 10 supporting the operation knobs 21 to 24. Particularly, two drain holes 30 arrayed in the horizontal direction Y are provided between the back-side tubes 10 supporting the operation knobs 21 and 22 and the front-side tubes 10 supporting the operation knobs 23 and 24. Two drain holes 30 arrayed in the horizontal direction Y are also provided between the front-side tubes 10 supporting the operation knobs 23 and 24 and the tubes 11 and 12 supporting the operation knobs 25 and 26.

A circuit board 6 is constructed by a printed wiring board, and a connector 8 is mounted at an end on a rear side. The connector 8 includes a connector terminal 81 that is connected to the circuit board 6 and a connector box 82 that accommodates the connector terminal 81 therein. As illustrated in FIG. 3, the connector box 82 includes an opening 8a that is opened in the direction (X-direction) parallel to a lower surface of the lower case 9. A terminal (not illustrated) of a cable is inserted in the opening 8a in order to connect the circuit board 6 to an external control device. In addition to the connector 8, a switch contact (not illustrated) that switches in response to the operation of the operation knobs 21 to 26 and an electronic component (not illustrated) constituting an electric circuit are also mounted on the circuit board 6. In the circuit board 6, rectangular through-holes 31 are formed at places corresponding to the drain holes 30 of the upper case 1.

As illustrated in FIG. 1, a window 91 is formed in the place corresponding to the connector 8 of the lower case 9. The connector 8 is exposed from the window 91 onto the rear side of the lower case 9. In the lower case 9, rectangular drain holes 32 (second drain hole) opened downward formed made at places corresponding to the drain holes 30 of the upper case 1 and the through-holes 31 of the circuit board 6. As illustrated in FIG. 8, the drain hole 32 is located right below the drain hole 30.

As illustrated in FIG. 3, a projection wall 92 projecting downward (D-direction) is provided on the lower surface of the lower case 9 so as to cover three side surfaces (except opening 8a) of the connector box 82. The projection wall 92 is molded by resin while being integral with the lower case 9. A wall portion 95, a wall portion 96, and a groove portion 93 are formed in the projection wall 92. A recess 94 in which a cable (not illustrated) connected to the connector 8 is accommodated is formed on the lower surface of the lower case 9.

As illustrated in FIG. 8, the drain hole 30 is opened upward, and the drain hole 32 is opened downward. The drain hole 30 and the drain hole 32 are communicated with each other through a hollow drain pipe 33. The drain pipe 33 is formed while being integral with the upper case 1, and pierces the through-hole 31 of the circuit board 6. A front end (lower end) 33a of the drain pipe 33 extends to the drain hole 32 of the lower case 9, and is fitted in the drain hole 32.

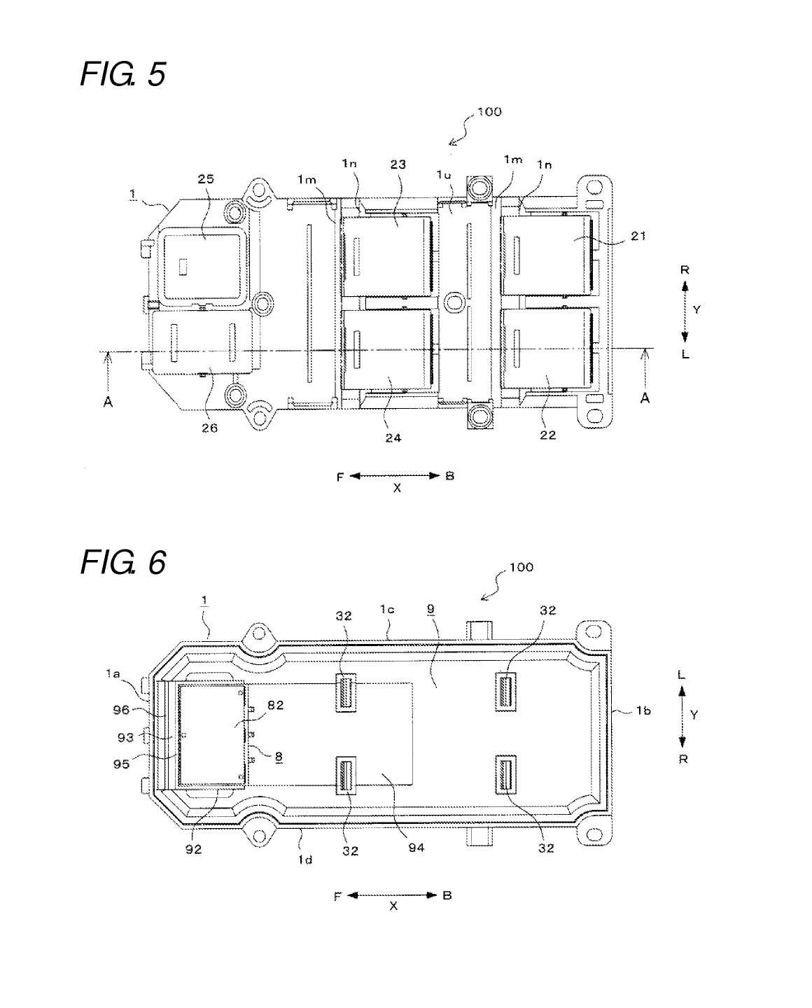

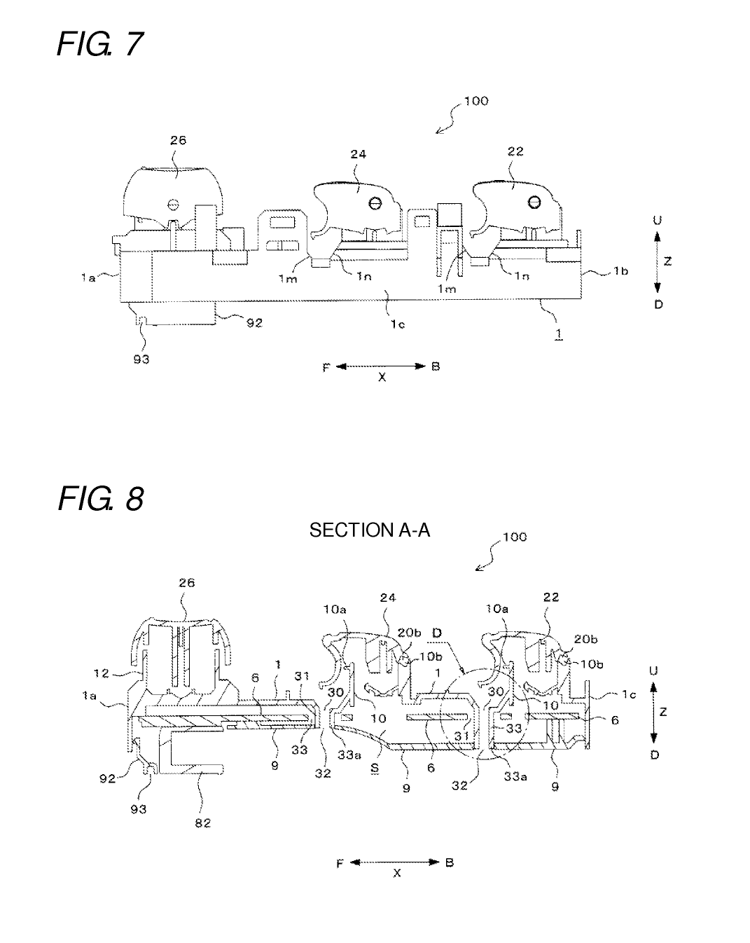

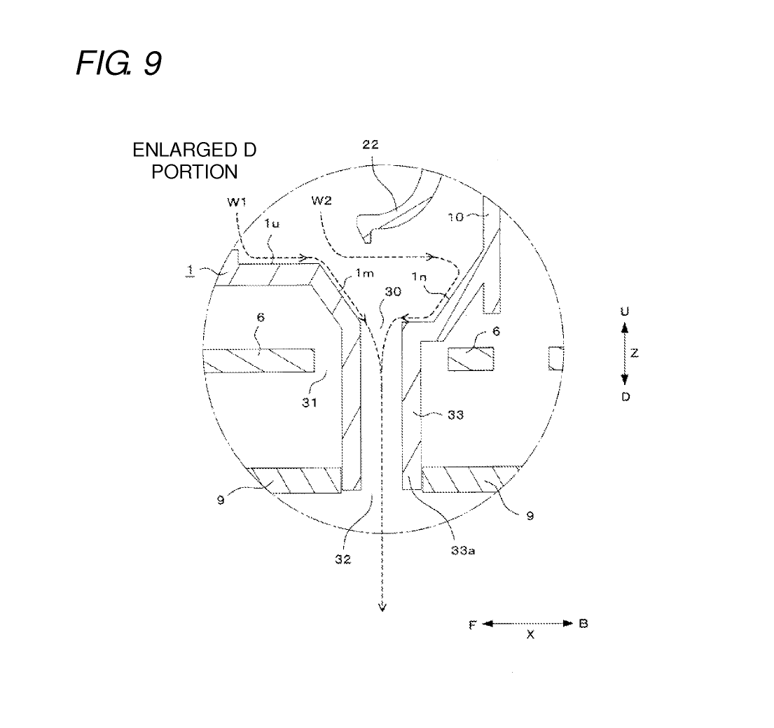

FIG. 9 is an enlarged cross-sectional view of D portion in FIG. 8. Referring to FIG. 9, slopes 1m and 1n are formed on an upper surface 1u of the upper case 1 in order to guide water W1 and water W2 to the drain hole 30. The slope 1m is provided in front (F-direction side) of the drain hole 30, and the slope 1n is provided at the back (B-direction side) of the drain hole 30. That is, a pair of slopes 1m and 1n is provided with the drain hole 30 interposed therebetween. As illustrated in FIG. 5, the slopes 1m and 1n extend over a length in a width direction (Y-direction) of the upper case 1.

Similarly the slopes 1m and 1n in FIG. 9 are provided for the drain holes 30 provided between the front-side tubes 10 supporting the operation knobs 23 and 24 and the tubes 11 and 12 supporting the operation knobs 25 and 26 (see FIG. 5).

In one or more embodiments of the present invention, the drain hole 30 is provided near the tube 10 of the upper case 1, the drain hole 32 is provided in the lower case 9 at the position corresponding to the drain hole 30, and the drain hole 30 and the drain hole 32 are communicated with each other through the drain pipe 33. Therefore, as indicated by a dashed line in FIG. 9, the flowing-down water W1 and W2 can be drained downward through the drain hole 30, the drain pipe 33, and the drain hole 32.

Accordingly, the water can be prevented from invading into the switch device 100 from the lower sides of the operation knobs 21 to 24 through the tubes 10. Since the ribs 10a are provided in the tubes 10, the water going round from the lower sides of the operation knobs 21 to 24 can more effectively be prevented from invading into the tubes 10.

In one or more embodiments of the present invention, the water is drained downward through the drain hole 32 provided on the rear side of the switch device 100. Therefore, the drained water can be prevented from invading undesirably into the case through the fitting portion between the upper case 1 and the lower case 9 along the sidewalls 1a to 1d of the upper case 1.

In one or more embodiments of the present invention, the slopes 1m and 1n are provided in front of and at the back of the drain hole 30, so that the water W1 and W2 can smoothly be guided to the drain hole 30 along the slopes 1m and 1n. Since the drain pipe 33 is provided between the drain hole 30 and the drain hole 32, the water does not leak in the case until the water entering the drain hole 30 exits from the drain hole 32. Therefore, the generation of shortcircuit caused by adhesion of water to the circuit board 6 can be avoided.

In one or more embodiments of the present invention, the wall portions 95 and 96 are provided near the connector box 82, and the groove portion 93 is formed between the wall portions 95 and 96. Even if the water flowing down along the sidewall 1a of the upper case 1 is about to flow along the lower surface of the connector box 82, the water flow is blocked by the groove portion 93. Therefore, the water does not go round the opening 8a of the connector box 82, but the water can be prevented from invading into the connector 8 and the switch device 100 through the opening 8a.

In the embodiment, the V-shape groove 10b in which both the ends are opened is provided in the tube 10 (see FIG. 1), and the inverse V-shape groove 20b corresponding to the groove 10b is provided in each of the operation knobs 21 to 24 (see FIG. 8). Therefore, the water invading into the tube 10 from behind the operation knobs 21 to 24 can be received by the grooves 10b and 20b and drained from both ends of each of the grooves 10b and 20b.

In addition to the above, various embodiments can be employed in the present invention. For example, in one or more of the above embodiments, the drain hole 30 of the upper case 1 and the drain hole 32 of the lower case 9 are communicated with each other through the drain pipe 33. Alternatively, the drain pipe 33 may be eliminated depending on the positions of the drain holes 30 and 32 or component dispositions in the case.

In one or more embodiments of the present invention, by way of example, the drain hole 32 of the lower case 9 is provided right below the drain hole 30 of the upper case 1. However, the drain hole 32 needs not be provided right below the drain hole 30. For example, in FIG. 8, the drain hole 30 and the drain hole 32 are provided while deviated from each other in the X-direction, and the drain holes 30 and 32 may be communicated with each other through the obliquely-provided drain pipe 33. Alternatively, the drain pipe 33 may be bent in midstream.

In one or more embodiments of the present invention, by way of example, the drain pipe 33 is formed while being integral with the upper case 1. Alternatively, the drain pipe 33 is formed while being integral with the lower case 9, and the front end (upper end) of the drain pipe 33 may extend to the drain hole 30 of the upper case 1. The drain pipe 33 is not necessarily formed while being integral with the upper case 1 or the lower case 9, but an individual drain pipe constructed by a hollow cylindrical body may be used.

In one or more embodiments of the present invention, the rectangular drain holes 30 and 32 are provided by way of example. However, the shapes of the drain holes 30 and 32 are not limited to the rectangular shape, but the drain holes 30 and 32 may be made into a circular or an elliptical shape. The same holds true for the through-hole 31 of the circuit board 6.

In one or more embodiments of the present invention, the front end 33a of the drain pipe 33 is fitted in the drain hole 32 by way of example. However, the front end 33a needs not be fitted in the drain hole 32. For example, in FIG. 9, the lower surface of the front end 33a of the drain pipe 33 may be flush with the upper surface of the lower case 9. In FIG. 9, the lower surface of the front end 33a of the drain pipe 33 is slightly retreated from the lower surface of the lower case 9. Alternatively, the lower surface of the front end 33a of the drain pipe 33 may be flush with the lower surface of the lower case 9. Alternatively, the front end 33a of the drain pipe 33 may slightly be projected from the drain hole 32.

In one or more embodiments of the present invention, the switch device 100 includes six operation knobs 21 to 26 by way of example. However, the number of operation knobs is not limited to six. The structure of the operation knob is not limited to those in the drawings. For example, one or more embodiments of the present invention can also be applied to the switch device including a rotary operation knob.

In one or more embodiments of the present invention, the vehicle automatic window switch is cited as an example of the switch device 100. Additionally, one or more embodiments of the present invention can also be applied to the switch devices used in applications except the vehicle.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A switch device comprising:
an operation part;
an upper case in which a hollow tube supporting the operation part is formed;
a lower case that is fitted in the upper case;
a first drain hole opened upward provided near the tube of the upper case; and
a second drain hole opened downward provided in the lower case,
wherein the second drain hole communicates with the first drain hole.

2. The switch device according to claim 1, wherein a slope is formed in an upper surface of the upper case in order to guide water to the first drain hole.

3. The switch device according to claim 2, wherein a pair of the slopes is provided with the first drain hole interposed therebetween.

4. The switch device according to claim 1, wherein the first drain hole and the second drain hole communicate with each other through a hollow drain pipe.

5. The switch device according to claim 4,
wherein the drain pipe is formed while being integral with the upper case or the lower case, and
wherein a front end of the drain pipe extends to the second drain hole or the first drain hole.

6. The switch device according to claim 4, further comprising:
a circuit board that is accommodated in an internal space formed by the upper case and the lower case,
wherein a through-hole pierced by the drain pipe is provided in the circuit board.

7. The switch device according to claim 2, wherein the first drain hole and the second drain hole communicate with each other through a hollow drain pipe.

8. The switch device according to claim 3, wherein the first drain hole and the second drain hole communicate with each other through a hollow drain pipe.

9. The switch device according to claim 5, further comprising:
a circuit board that is accommodated in an internal space formed by the upper case and the lower case,
wherein a through-hole pierced by the drain pipe is provided in the circuit board.
